(19) United States
(12) Patent Application Publication
(10) Pub. No.: US 2009/0103239 A1
(43) Pub. Date: Apr. 23, 2009

(54) Dielectric Fluid for Improved Capacitor Performance

(76) Inventors: Clay Lynwood Fellers, Little Mountain, SC (US); Marco James Mason, Greenwood, SC (US); Alan Paul Yerges, Muskego, WI (US); Lisa Carol Sletson, Waterford, WI (US); Gary Arden Gauger, Franklin, WI (US)

Correspondence Address: KING & SPALDING, LLP, 1100 LOUISIANA ST., STE. 4000, ATTN.: IP Docketing, HOUSTON, TX, 77002-5213, US

(21) Appl. No.: 12/253,805

(22) Filed: Oct. 17, 2008

Related U.S. Application Data
(60) Provisional application No. 60/981,041, filed on Oct. 18, 2007.

(51) Int. Cl. H01G 4/04; C08K 5/09

(52) U.S. Cl. 361/327; 524/396

(57) ABSTRACT

A dielectric fluid that provides improved resistance to device failure in capacitors comprising combinations of certain anthraquinone compounds and scavengers. Capacitors including the dielectric fluid can have a higher discharge inception voltage and can have increased failure threshold voltages in comparison to capacitors made without the combination. Therefore, these capacitors are more resistant to failures.

### CROSS REFERENCE TO RELATED APPLICATIONS

This application claims priority benefit, under 35 U.S.C. § 119(e), of U.S. Provisional Patent Application 60/981,041, filed Oct. 18, 2007, the contents of which application are hereby incorporated by reference in their entirety.

### FIELD OF INVENTION

The present invention relates generally to compositions for a dielectric fluid. More particularly, the present invention relates to compositions for a dielectric fluid of a capacitor having improved resistance to failure.

### BACKGROUND OF THE INVENTION

Capacitors are electrical devices that may be used to store an electrical charge. A capacitor may include at least one capacitor pack comprising conducting plates separated by a non-conductive material, such as a polymer film. The conducting plates and non-conductive material may be rolled to form windings. The windings may be housed within a casing, such as, for example, a metal or plastic housing. The casing protects and electrically isolates the windings from the environment. In power factor correction capacitors, the windings typically are immersed in a dielectric fluid. The dielectric fluid serves as an insulating material to prevent partial charge breakdown in the spaces between the plates of the capacitor. If these spaces are not filled with a suitable dielectric material, partial discharge can occur under electrical stress, leading to device failure.

A conventional technique for avoiding device failures is to optimize the design specifications for the capacitor, such as, for example, by decreasing the design target for electrical stress imposed on the capacitor and/or optimizing the thickness of the polymeric film within the capacitor. However, changes in the design specifications for the capacitor may restrict the functionality of a device, increase the size of the device, and/or raise the cost for manufacturing the device. Therefore, a continuing need exists in the art for alternative techniques for avoiding device failures that overcome one or more of the foregoing deficiencies. It would be desirable to provide an improved capacitor with increased resistance to partial discharge or charge breakdown without changing the design specifications and/or increasing the size of the device.

It is therefore an object of the invention to provide a dielectric fluid with improved resistance to partial discharge or charge breakdown.

The foregoing discussion is presented solely to provide a better understanding of nature of the problems confronting the art and should not be construed in any way as an admission as to prior art to this application.

### SUMMARY OF INVENTION

A dielectric fluid that provides improved resistance to device failure in capacitors comprises combinations of certain anthraquinone compounds and scavengers. In particular, the dielectric fluid of the invention can reduce the likelihood of device failure at elevated ambient temperatures without sacrificing performance at other temperature ranges. Capacitors including the dielectric fluid can have a higher discharge inception voltage and can have increased failure threshold voltages in comparison to capacitors made without the combination. Therefore, these capacitors are more resistant to certain failures.

In one exemplary aspect of the invention, the dielectric fluid may comprise β-methylanthraquinone and an epoxide. The dielectric fluid may comprise (i) β-methylanthraquinone at a weight percent from about 0.1 to about 3, preferably from about 0.3 to about 0.8, more preferably, from about 0.3 to about 0.6, and most preferably from about 0.35 to about 0.5; and (ii) an epoxide at a weight percent from about 0.1 to about 1, preferably, from about 0.5 to about 0.9, and more preferably, at about 0.6.

In another exemplary aspect of the invention, the amount of epoxide to the amount of β-methylanthraquinone can be at a ratio of about 1 to about 10, typically, from about 1.0 to about 3.0, preferably, from about 1.2 to about 2.8, and more preferably, from about 1.8 to about 2.5. Alternatively, the amount of epoxide to the amount of β-methylanthraquinone can be at a ratio of about 1.5 to about 1.7.

These and other aspects, objects, and features of the present invention will be better understood by reference to the following detailed description of the exemplary embodiments, read in conjunction with, and reference to, the accompanying drawings.

### BRIEF DESCRIPTION OF THE DRAWINGS

FIG. 1 is a perspective view of a capacitor according to an exemplary embodiment.

FIG. 2 is a perspective view of a capacitor pack of the capacitor illustrated in FIG. 1 according to an exemplary embodiment.

FIG. 3 illustrates the percent of rated AC voltage at which a dielectric failure occurred at room temperature and at an elevated temperature for mini-capacitors filled with a dielectric fluid comprising β-methylanthraquinone (“BMAQ”) and for mini-capacitors filled with a control dielectric fluid absent BMAQ.

FIG. 4 illustrates the number of minutes for mini-capacitors, filled with either a dielectric fluid comprising BMAQ or a control dielectric fluid absent BMAQ, at −40° C. to withstand a DC voltage at 130% of the rated voltage.

FIG. 5 illustrates the average DC breakdown voltage, in kilovolts, for mini-capacitors of different designs, filled with either a dielectric fluid comprising BMAQ or a control dielectric fluid absent BMAQ, and aged and operated at a high temperature.

FIG. 6 illustrates the AC and DC breakdown voltages, in kilovolts, for mini-capacitors of different designs, filled with either a dielectric fluid comprising BMAQ or a control dielectric fluid absent BMAQ, and aged and operated at a high temperature.

FIG. 7 illustrates the DC breakdown voltages, in kilovolts, for mini-capacitors, filled with either a dielectric fluid comprising BMAQ or a dielectric fluid absent BMAQ, aged under different conditions, and operated at either room temperature or 75° C.

### DETAILED DESCRIPTION OF EXEMPLARY EMBODIMENTS

In the following description of the exemplary embodiments of the invention, it is to be understood that the terms used herein have their ordinary and accustomed meanings in the art, unless otherwise specified. All weight percentages referred to herein are given in terms of “% by weight” of the total composition for a dielectric fluid, unless otherwise indicated.

The present invention is founded on the discovery that additives to dielectric fluids comprising anthraquinone compounds and combinations of certain anthraquinone compounds and scavengers improve the dielectric properties of a dielectric fluid, particularly at elevated ambient temperatures. Such elevated ambient temperature may include any temperature above room temperature. For example, an elevated ambient temperature may be at or above 40° C., at or above 55° C., at or above 60° C., at or above 65° C., or at or above 75° C. Specifically, these additives provide an improvement in resistance to partial discharge or dielectric DC breakdown. The resistance to partial discharge or charge breakdown may be quantified on the basis of discharge inception voltage (DIV) or DC voltage withstand capability. Furthermore, it has been observed that the addition of these additives does not significantly sacrifice performance of the dielectric fluids at other temperature ranges.

One additive is an anthraquinone compound. The anthraquinone compound may include, for example, β-methylanthraquinone (CAS # 84-54-8) or β-chloranthraquinone (CAS # 131-09-9). In an exemplary embodiment, the dielectric fluid comprises β-methylanthraquinone (“BMAQ”), having the structure shown in formula I,

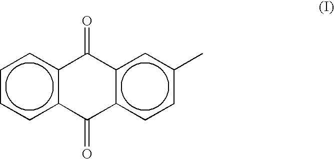

BMAQ is commercially available as a powder from about 95% to above 99% purity from a number of commercial vendors, including Sigma Aldrich and Alfa Aesar/Avacado. The dielectric fluid may comprise BMAQ at a weight percent from about 0.1 to about 3, preferably from about 0.3 to about 0.8, more preferably, from about 0.3 to about 0.6, and most preferably from about 0.35 to about 0.5. Alternatively, the dielectric fluid may comprise BMAQ at a weight percent from about 0.4 to about 0.8, preferably from about 0.4 to about 0.6. For example, BMAQ may be present in the dielectric fluid at about 0.5 weight percent. In another exemplary embodiment, BMAQ may be present in the dielectric fluid at about 0.4 weight percent.

Another additive is a scavenger. The scavenger can neutralize decomposition products that are released or generated within the capacitor during operation. The scavenger can also improve the service life of the capacitor. The scavenger may include an epoxide compound, preferably a di-epoxide generally having the following structure (formula II),

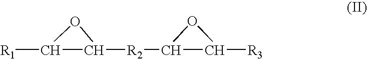

Examples of suitable epoxide compounds include 1,2-epoxy-3-phenoxypropane, bis(3,4-epoxycyclohexylmethyl)adipate, 3,4-epoxycyclohexylmethyl-(3,4-epoxy)cyclohexane carboxylate, bis(3,4-epoxy-6-methylcyclohexylmethyl)adipate, 3,4-epoxy-6-methylcyclohexylmethyl-4-epoxy-6-methylcyclohexanecarboxylate, diglycidyl ethers of bisphenol A, or similar compounds. In one exemplary embodiment, the scavenger is a cycloaliphatic epoxide resin, including, for example, bis(3,4-epoxycyclohexyl)adipate, commercially sold under the designation ERL-4299 (Dow Chemical Co.), 3,4-epoxycyclohexylmethyl 3,4-epoxycyclohexanecarboxylate, commercially sold under the designation ERL-4221 (Dow Chemical Co.) and (3′,4′-epoxycyclohexane)methyl, 3,4-epoxycyclohexyl-carboxylate (CAS #2386-87-0), commercially sold under the designation Celloxide 2021P (Daicel Chemical Industries, Ltd.).

In accordance with another exemplary embodiment of the invention, dielectric fluids comprising BMAQ and an epoxide as additives for improving resistance to partial discharge or DC breakdown, particularly at elevated ambient temperatures, are provided. The additives may be included in any suitable dielectric fluid. Preferably, the dielectric fluid comprises at least one aromatic hydrocarbon, such as benzyltoluene, 1,1-diphenylethane, 1,2-diphenylethane, diphenylmethane, 1, phenyl-1-(3,4 xylyl ethane), polybenzylated toluenes, and the like. The dielectric fluid can have a low viscosity and a low vapor pressure.

In one embodiment, the additives may be added to a dielectric fluid comprising benzyltoluene, diphenylethane and diphenylmethane. The benzyltoluene may include orthomonobenzyltoluene, meta-monobenzyltolunene, paramonobenzyltoluene or combinations thereof. The benzyltoluene will typically comprise about 15 to about 65% of the dielectric fluid. In one embodiment, the benzyltoluene may comprise about 15 to about 40% of the dielectric fluid. In another embodiment, the benzyltoluene may comprise from about 52 to about 65% of the dielectric fluid. In particular, the benzyltoluene may comprise 60.9% of the dielectric fluid. Alternatively, the benzyltoluene may comprise from about 36 to about 50% and specifically may comprise 45% of the dielectric fluid.

The diphenylethane may include 1,1-diphenylethane and 1,2-diphenylethane. Typically, the dielectric fluid will comprise about 33 to about 85% diphenylethane. In one embodiment, the dielectric fluid may comprise about 50 to about 60% diphenylethane. In this embodiment, the dielectric fluid may specifically comprise 53.1% diphenylethane. Moreover, the dielectric fluid may comprise less than about 5 percent by weight of 1,2-diphenylethane, preferably from about 0.1 to about 5 percent by weight of 1,2-diphenylethane, more preferably from about 0.1 to about 3 percent by weight of 1,2-diphenylethane, and most preferably from about 0.1 to about 0.5 percent by weight of 1,2-diphenylethane. In another embodiment, the dielectric fluid may comprise about 60 to about 85% diphenylethane. In particular, the dielectric fluid may comprise about 60 to about 80% 1,1-diphenylethane and about 0.1 to about 5% 1,2-diphenylethane. In an alternative embodiment, the dielectric fluid may comprise about 33 to about 44% 1,1-diphenylethane and about 0.1 to about 2% 1,2-diphenylethane. In one particular embodiment, the dielectric fluid may comprise 35.4% 1, 1-diphenylethane and 1.2% 1,2-diphenylethane.

The diphenylmethane typically will comprise from about 0.1 to about 5% of the dielectric fluid. More typically, the diphenylmethane may comprise from about 0.1 to about 4% of the dielectric fluid. In one exemplary embodiment, the diphenylmethane may comprise from about 0.1 to about 2% of the dielectric fluid. In a particular exemplary embodiment, the diphenylmethane may comprise 1.2% of the dielectric fluid. Alternatively, the dielectric fluid may comprise 0.8% diphenylmethane.

The additives according to the exemplary embodiments of the present invention may be added to a conventional dielectric fluid. Exemplary suitable conventional dielectric fluids are commercially available under the designation SAS-40, SAS-60, SAS-60E, and SAS-70, SAS-70E from Nisseki Chemical Texas, Inc. In addition, other exemplary suitable conventional dielectric fluids are commercially available under the trade designations “Edisol ST,” “Edisol XT,” and “Envirotemp” from Cooper Industries, Inc. and JARYLEC® C-100 from Arkema Canada Inc.

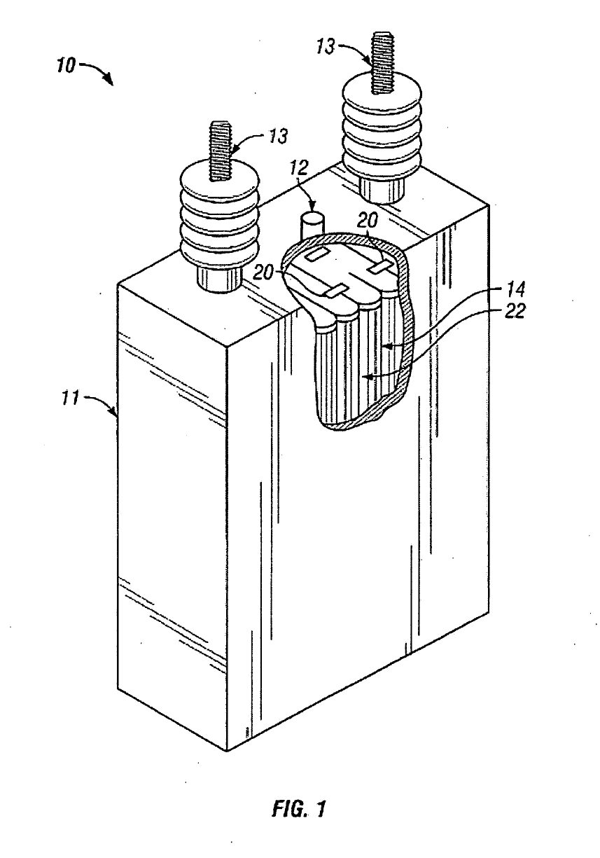

A dielectric fluid according to the exemplary embodiments of the present invention may be used to fill any type of dielectric devices, such as capacitors and transformers. Preferably, the dielectric fluid of the present invention may be used in dielectric capacitors. More preferably, the dielectric fluid of the present invention may be used in alternate-current (AC) capacitors. The dielectric capacitors may have any suitable design characteristics. In the examples provided below, the capacitors comprise either 2 or 3 dielectric layers, each having a total thickness of 1.2 mil. However, one skilled in the art would understand that the dielectric fluids of the present invention may be used to fill capacitors of any suitable design and is not restricted to the exemplary capacitor design characteristics provided herein. It is also preferred that the capacitors are suitable for operation at an elevated ambient temperature. Referring to FIG. 1, an exemplary embodiment of a capacitor 10 includes a casing 11, which encloses capacitor packs 14. A fill tube 12 may be positioned at the top of casing 11, which allows the internal region of the capacitor to be dried under reduced pressure and permits dielectric fluid 22 to be added to the capacitor.

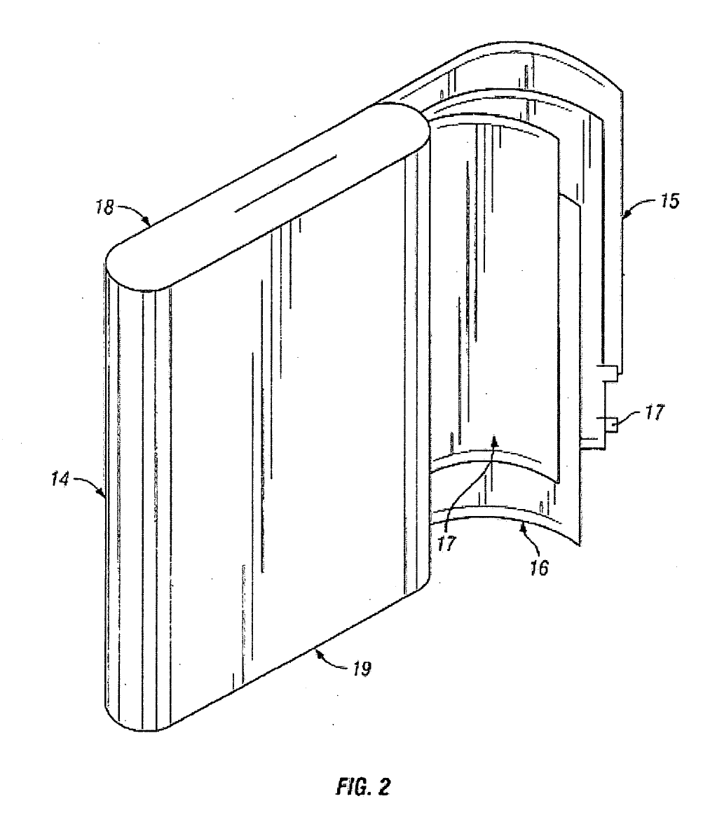

Referring to FIG. 2, an exemplary embodiment of a capacitor pack 14 includes two (2) wound layers of metal foil 15, 16 separated by a dielectric layer 17. The dielectric layer 17 can be composed of one or multiple layers. The foils 15, 16 are offset with respect to the dielectric layer 17 and with respect to each other such that the foil 15 extends above the dielectric layer 17 at pack top 18 and the foil 16 extends below the dielectric layer 17 at pack bottom 19.

Referring to FIG. 1, the capacitor packs 14 can be connected together by a crimp 20 that holds the extended portions of the foils 15, 16 of one pack in intimate contact with extended foils of adjacent packs. The extended portions of the foils 15, 16 can be insulated from adjacent packs to provide a series arrangement of the packs 14 in the capacitor 10. After the dielectric fluid 22 has been added to the capacitor 10 through the tube 12, the internal region of the capacitor may be sealed, for example, by crimping the tube 12. Two terminals 13, which may be electrically connected to crimps near the end packs by lead wires (not shown), may project through the top of the casing 11. At least one terminal may be insulated from the casing 11. The terminals 13 can be connected to an electrical system.

Referring to FIG. 2, the foils 15, 16 can be formed of any desired electrically conductive material, such as, for example, aluminum, copper, chromium, gold, molybdenum, nickel, platinum, silver, stainless steel, or titanium. The dielectric layer 17 can be composed of polymeric film or kraft paper. The polymeric film may be made, for example, from polypropylene, polyethylene, polyester, polycarbonate, polyethylene terephthalate, polyvinylidene fluoride, polysulfone, polystyrene, polyphenylene sulfide, polytetrafluoroethylene, or similar polymers. The surface of the dielectric layer 17 of the foils 15, 16 may have surface irregularities or deformations sufficient to allow the dielectric fluid to penetrate the wound pack and to impregnate the spaces between the foils and the dielectric layer.

The dielectric fluid 22 may be added to the capacitor after the capacitor is dried under reduced pressure. Specifically, the capacitor casing 11 containing the capacitor packs 14 can be dried for a period of time sufficient to remove water vapor and other gases from the interior of the capacitor 10. A pressure of less than 500 microns is usually employed, with some implementations using a pressure below 100 microns. A drying period longer than 40 hours can be used, although the time period depends on the magnitude of the reduced pressure. Drying can take place at a temperature higher than room temperature, and generally can be conducted at temperatures less than 100° C.

The dielectric fluid 22 also may be degassed prior to introducing it into the capacitor 10. The fluid 22 can be subjected to reduced pressure treatment, for example, at a pressure of less than 200 microns, or less than 100 microns. The fluid 22 can be agitated, for example by circulation, stirring or mixing, to assist in the degassing process. The time of degassing depends upon the viscosity of the fluid 22, the magnitude of the reduced pressure, and the type of agitation used. In general, the fluid 22 can be degassed at a temperature below 60° C., such as room temperature.

The degassed dielectric fluid 22 can be introduced into the evacuated capacitor casing 11 by adding the fluid 22 to the capacitor 10 through the tube 12. After filling, reduced pressure can be applied to the interior of the capacitor 10 to soak the fluid 22 into the packs 14. A soak time of twelve hours or more can be used. Positive pressure, for example, in the range of about 0.1 to 5.0 psig, can then be applied to the interior of the capacitor 10 for a period of about 6 hours or more to assist in impregnating the packs 14 with the fluid 22. The casing 11 can then be sealed, for example, while maintaining some positive pressure.

It is contemplated that the additives described herein may be incorporated into a dielectric fluid by any suitable method. In one embodiment, the additives are added to dielectric fluid raw materials in a concentrate form. Subsequently, the concentrate may be reconstituted to a suitable concentration for use in a capacitor. In another embodiment, concentrates of each additive are prepared and individually added to a dielectric fluid and diluted to a suitable concentration. These embodiments allow for even distribution of the additives for commercial scale manufacturing of the dielectric fluid, a more robust manufacturing process, and/or an easier preparation. As an optional step, the dielectric fluid with the inventive additives may be filtered to remove any remaining particles.

Optionally, the amount of additives included within the reconstituted dielectric fluid may be analyzed and verified before introducing the dielectric fluid into a capacitor. For example, a sample of the reconstituted dielectric fluid may be analyzed using chromatography to determine the concentrations of additives included therein. If results of the analysis are in good agreement with the desired concentrations of additives, then the dielectric fluid may be added to a capacitor. Otherwise, the dielectric fluid may be mixed further and/or modified until the desired concentrations of additives are obtained.

It has been observed that certain combinations of an anthraquinone compound and a scavenger form precipitates when mixed together in the dielectric fluid. For example, it has been observed that a solution comprising above 2% of a commercial supply of BMAQ (Alfa Aesar, 97% purity) in a commercial dielectric fluid SAS-40 (Nisseki Chemical Texas, Inc.) form a solid residue when introduced into a dielectric fluid containing the epoxide ERL-4299 (Dow Chemical Co.). However, it is expected that this issue can be remedied by utilizing commercial sources of BMAQ with high levels of purity and/or filtration of insoluble contaminants from the BMAQ concentrate prior to introduction into a dielectric fluid comprising an epoxide. Alternatively, it is expected that this issue can also be remedied by clay treatment of the BMAQ concentrate prior to introduction into a dielectric fluid comprising an epoxide. Clay treatment is an irreversible absorptive process for removing polar contaminants, which contribute to dielectric breakdown, from dielectric fluids. Clay treatment can improve the dielectric properties of the BMAQ concentrate. Suitable amounts of the anthraquinone compound, such as BMAQ, and/or of the scavenger, such as the epoxide ERL-4299, in the concentrate(s) may be at a level that will not promote the formation of precipitates.

Suitable amounts of the anthraquinone compound, such as BMAQ, and of the scavenger, such as the epoxide ERL-4299, in the dielectric fluid may be at a level that will not promote the formation of precipitates. For example, the dielectric fluid may comprise about 0.1% to about 3% BMAQ, along with about 0.1% to about 1% ERL-4299. In one exemplary embodiment, the dielectric fluid may comprise about 0.4% to about 0.8% BMAQ, along with about 0.5% to about 0.9% ERL-4299. In another exemplary embodiment, the dielectric fluid may comprise about 0.4% to about 0.6% BMAQ, along with about 0.5% to about 0.9% ERL-4299. In a particular exemplary embodiment, the dielectric fluid may comprise about 0.5% BMAQ, along with about 0.6% ERL-4299.

Suitable amounts of the scavenger, such as the epoxide ERL-4299, and of the anthraquinone compound, such as BMAQ, in the dielectric fluid may be at a ratio that will not promote the formation of precipitates. For example, the dielectric fluid may comprise ERL-4299 and BMAQ at a ratio of about 2 to about 10. In one exemplary embodiment, the dielectric fluid may comprise BMAQ and ERL-4299 at a ratio of about 1.0 to about 3.0. In another exemplary embodiment, the dielectric fluid may comprise ERL-4299 and BMAQ at a ratio of about 1.2 to about 2.8. In a particular exemplary embodiment, the dielectric fluid may comprise ERL-4299 and BMAQ at a ratio of about 1.8 to about 2.5. Alternatively, the dielectric fluid may comprise ERL-4299 and BMAQ at a ratio of about 1.5 to about 1.7.

The combination of an anthraquinone and a scavenger in a dielectric fluid may provide improved resistance to device failures, particularly when the device is operated at an elevated ambient temperature, which is typically above 55° C. and more typically at or about 75° C. The improvement may manifest as an additive or a synergistic improvement in a variety of characteristics of the dielectric fluid. For example, the combination may provide improved resistance to partial discharge or DC breakdown. The resistance to partial discharge or charge breakdown may be quantified on the basis of discharge inception voltage (DIV) or DC voltage withstand capability.

The discharge inception voltage (DIV) measures the threshold voltage where partial discharge occurs as the voltage is increased in a liquid dielectric system. The DIV is a primary limiting design parameter of an AC capacitor because operation of a capacitor at a voltage greater than or equal to the DIV will quickly lead to failure of the equipment. Typically, an AC capacitor is designed with a normal operating voltage applied to the capacitor that is selected such that the DIV is at least 180% of the operating voltage at a select temperature, such as room temperature or an elevated ambient temperature. This design limitation prevents the capacitor from being excessively exposed to damaging discharges under desired operating conditions. Therefore, an increase in the DIV of the dielectric fluid may increase the reliability of the equipment (in other words, reduce the potential for equipment failure or damage from transient over-voltages) and/or may provide an improved capacitor capable of resisting a greater amount of electrical stress. Alternatively or additionally, an increase in the DIV of a dielectric system may allow for a more efficient use of materials in constructing a capacitor, which in turn may result in a smaller unit size and/or lower cost. In certain circumstances, this lower cost may equal or surpass the additional cost due to new materials.

Dielectric systems comprising dielectric fluids according to the exemplary embodiments described herein is expected to provide improved resistance to partial discharge to dielectric systems at electrical stresses encountered during typical use at room temperature or at an elevated ambient temperature. Typical electrical stresses may be quantified by the operating voltage of a capacitor at a select temperature.

The DC voltage withstand capability quantifies the amount of electrical stress a capacitor can resist under DC applications. Electrical discharges result in deterioration of the dielectric properties of the insulating system, and potentially to the failure of the equipment. Therefore, it would be desirable to impart improved charge breakdown resistance to dielectric fluids at electrical stresses encountered during typical use, at room temperature or at an elevated ambient temperature. Dielectric fluids according to the exemplary embodiments described herein can provide such improvement.

### EXAMPLES

### Mini-Capacitors

### AC to DC Switch Testing

The ability of a combination of anthraquinone and a scavenger to improve resistance to device failures was investigated by preparing mini-capacitors having dielectric fluids comprising the combination. The exemplary mini-capacitors possessed at least the following characteristics: 1.2 mil pad thickness, 2200 V rated, 15 inches in active area, and 14-15 nF capacitance. Comparative compositions, Examples 1 through 4, were each prepared in small batches in the laboratory by adding BMAQ and ERL-4299 (Dow Chemical Co.) according to Table 1 to a commercial dielectric fluid, SAS40, whereas ERL-4299, but not BMAQ, was added in the Control A sample.

TABLE 1

| | Control A | Example 1 | Example 2 | Example 3 | Example 4 |
|---|---|---|---|---|---|
| Components | Weight % | | | | |
| BMAQ | — | 0.4 | 0.8 | 0.8 | 0.4 |
| (Alfa Aesar, | | | | | |
| 97% purity) | | | | | |
| ERL-4299 | 0.8 | 0.4 | 0.4 | 0.8 | 0.8 |
| (Dow | | | | | |
| Chemical) | | | | | |
| epoxide | | | | | |
| scavenger | | | | | |

Mini-capacitors having two (2) dielectric layers with a 1.2 mil pad thickness and mini-capacitors having three (3) dielectric layers with a 1.2 pad thickness were filled as follows. The casings were placed in a vacuum chamber at room temperature under atmospheric conditions. A vacuum is applied to the chamber for four (4) days at a level of between 25 and 30 microns of Hg. Thereafter, the dielectric fluids of Table 1 were introduced into the vacuum chamber to prepare the mini-capacitors. The mini-capacitors were prepared by filling or impregnating the casings with a dielectric fluid. The vacuum level in the chamber did not exceed 50 microns during the filling or impregnation process.

Mini-capacitors having varied capacitor pack designs were constructed. To simulate repeated use, the mini-capacitors were aged for 1000 hours at an elevated ambient temperature of 75° C. Tests were conducted at an elevated ambient temperature of 75° C. on five (5) mini-capacitors for each dielectric fluid and capacitor design using a partial discharge detector to determine the DIV, the voltage at which partial discharges occur, and the discharge extinction voltage (DEV), the voltage at which partial discharges are no longer observed. Generally, the partial discharge detector provides an increasing voltage until DIV is detected. The voltage may initially increase at a rate of 1 kV/s and reduce to a rate of 100 V/s when the overall voltage approaches the expected DIV. Subsequently, a decreasing voltage may be applied to the mini-capacitor until a partial discharge is no longer detected.

The results show that mini-capacitors having two (2) and three (3) dielectric layers filled with dielectric fluid comprising BMAQ did not demonstrate a significant change in the dissipation factor. The results are provided below in Table 2.

TABLE 2

| | Number of | Average | | Number of | Average | |
|---|---|---|---|---|---|---|
| Dielectric | Dielectric | Dissipation | Standard | Dielectric | Dissipation | Standard |
| Fluid | Layers | Factor | Deviation | Layers | Factor | Deviation |
| Control A | 2 | 0.0144 | 0.00849 | 3 | 0.0109 | 0.00237 |
| Example 1 | 2 | 0.0130 | 0.00348 | 3 | 0.0144 | 0.00335 |
| Example 2 | 2 | 0.0184 | 0.00153 | 3 | 0.0163 | 0.00378 |
| Example 3 | 2 | 0.0143 | 0.00106 | 3 | 0.0161 | 0.00634 |
| Example 4 | 2 | 0.0128 | 0.00210 | 3 | 0.0134 | 0.00175 |

To simulate typical operating failure conditions, after aging for 1000 hours at 75° C., ten (10) mini-capacitors for each of Control A and Examples 1 and 2 and nine (9) mini-capacitors for each of Examples 3 and 4 were maintained at an ambient temperature of 75° C. and subjected to a raised AC voltage and subsequently exposed to a DC voltage. Specifically, the mini-capacitors were subjected to an AC voltage of 4750V rms for five (5) minutes and then exposed to a DC Charge at 6698V for another five (5) minutes. These particular voltages were selected because under these conditions, mini-capacitors filled with the Control A dielectric fluid demonstrated a high failure rate.

The results indicate that the dielectric fluids of Examples 1 through 4, comprising BMAQ, provide better resistance to device failure at an elevated temperature than Control A, which does not contain BMAQ. Of these compositions, Example 4, comprising 0.4% BMAQ and 0.8% ERL-4299, provided the most significant improvement in resistance to device failure as compared to Control A. The results are provided below in Table 3.

TABLE 3

| | | | | Ex- | Ex- |
|---|---|---|---|---|---|
| | Control A | Example 1 | Example 2 | ample 3 | ample 4 |
| Total | 10 | 10 | 10 | 9 | 9 |
| Mini-Capacitors | | | | | |
| Mini-Capacitor | | | | | |
| Failures: | | | | | |
| Failed During AC | 9 | 4 | 2 | 2 | 1 |
| Voltage Period | | | | | |
| Failed During DC | — | 1 | 2 | 0 | 0 |
| Voltage Period | | | | | |
| Total Failures: | 9 | 5 | 4 | 2 | 1 |

### Step Stress Testing

The ability of dielectric fluids comprising a combination of anthraquinone and a scavenger to withstand electrical stresses under various temperatures was investigated using exemplary mini-capacitors. Mini-capacitors comprising capacitor packs having two (2) dielectric layers and mini-capacitors comprising capacitor packs having three (3) dielectric layers were constructed using the method described above for the AC to DC Switch Testing. These mini-capacitors were filled with dielectric fluids prepared in small batches in the laboratory and having comparative compositions, Examples 5 and 6, which comprise BMAQ and ERL-4299 according to Table 5. The control (Control A) remains the same as above. All materials used in the compositions in Table 5 are the same as previously described.

TABLE 5

| | Control A | Example 5 | Example 6 |
|---|---|---|---|
| Components | Weight % | | |
| BMAQ | — | 0.4 | 0.8 |
| (Alfa Aesar, 97% | | | |
| purity) | | | |
| ERL-4299 | 0.8 | 0.8 | 0.8 |
| (Dow Chemical) | | | |
| epoxide scavenger | | | |

Three (3) mini-capacitors comprising capacitor packs having two (2) dielectric layers having a pad thickness of 1.2 mil were constructed for each of Control A, Example 5 and Example 6. In addition, three (3) mini-capacitors having three (3) dielectric layers having a pad thickness of 1.2 mil were constructed for Example 5. These mini-capacitors were equilibrated and unenergized at room temperature overnight. The ambient temperature was maintained at room temperature throughout the test. The mini-capacitors were energized and operated for 30 minutes at 130% of the rated voltage. For this particular example, the rated voltage of the mini-capacitors was 2.64 kV and the initial step was at 3.43 kV. The mini-capacitors were then de-energized for a period of at least 4 hours. Subsequent to de-energizing, the mini-capacitors were re-energized and operated for 30 minutes at a 10% increase (e.g., a 264 V increase), which is 140% of the rated voltage. The mini-capacitors were de-energized overnight. The de-energize/re-energize cycles were repeated at 10% increments (i.e., at 150%, 160%, 170%, 180%, 190% and 200% of rated voltage) until dielectric failure occurred.

The result suggests that the addition of BMAQ to a dielectric fluid has no significant affect on the resistance of room temperature aged mini-capacitors to device failure. With regards to the room temperature step stress data, Control A mini-capacitors having 2 dielectric layers and a pad thickness of 1.2 mil showed failures within a range of 170 to 180% of the rated voltage. In particular, 67% of the Control A mini-capacitors failed at 170% of the rated voltage. Mini-capacitors having the same characteristics but filled with dielectric fluids of Examples 5 and 6 showed failures in a similar range as the Control A mini-capacitors, specifically at 180% of the rated voltage. However, it has been observed that BMAQ may provide a marginal improvement to the resistance of room temperature aged mini-capacitors to device failure. Notably, all of the mini-capacitors having 2 dielectric layers and a pad thickness of 1.2 mil and filled with either Example 5 or 6 failed at 180% of the rated voltage, demonstrating a consistently higher resistance. In contrast, the mini-capacitors for the Control A dielectric fluid show a failure level of 180% of the rated voltage only for 33% of the Control A mini-capacitors tested. The results for the room temperature step stress tests are shown below in Table 6.

TABLE 6

| | Control A | Example 5 | | Example 6 |
|---|---|---|---|---|
| Number of Dielectric Layers: | 2 | 2 | 3 | 2 |
| Failure Level | 170 | 180 | 180 | 180 |
| (% of Rated Voltage) | 180 | 180 | 180 | 180 |
| | 170 | 180 | 170 | 180 |

Mini-capacitors having a pad thickness of 1.2 mil and filled with the Control A dielectric fluid or dielectric fluids comprising BMAQ were prepared using the method described above for the AC to DC Switch Testing. Tests were conducted at room temperature on three (3) mini-capacitors for each dielectric fluid and capacitor design These mini-capacitors were aged at room temperature overnight. Tests were conducted at room temperature for these mini-capacitors to determine the DIV and discharge extinction voltage (DEV). The results show that the addition of BMAQ to a dielectric fluid does not result in any detrimental performance at room temperature. The results are shown below in kilovolts (kV) in Table 7.

TABLE 7

| | | Control A | | Example 5 | | Example 6 | |
|---|---|---|---|---|---|---|---|
| | | Number of Dielectric Layers: | | | | | |
| | | 2 | 3 | 2 | 3 | 2 | 3 |
| DIV | Avg. | 5.010 | 5.156 | 5.517 | 5.215 | 5.056 | 5.262 |
| (kV) | St. Dev. | 0.1078 | 0.0163 | 0.0660 | 0.0800 | 0.0392 | 0.0547 |
| DEV | Avg. | 3.405 | 3.386 | 3.560 | 3.347 | 3.261 | 3.411 |
| (kV) | St. Dev. | 0.0756 | 0.0615 | 0.1469 | 0.3039 | 0.3357 | 0.1066 |

Three (3) mini-capacitors comprising capacitor packs having two (2) dielectric layers were constructed for each of Control A, Example 5, and Example 6. In addition, three (3) mini-capacitors comprising capacitor packs having three (3) dielectric layers were constructed for each of Control A, Example 5, and Example 6. A second step stress test was conducted using these mini-capacitors. These mini-capacitors were equilibrated and unenergized at an elevated ambient temperature of 75° C. overnight. The ambient temperature was maintained at 55° C. throughout the second step stress test. The mini-capacitors were energized and de-energized until dielectric failure occurred using the method described above.

The results demonstrate that the addition of BMAQ to a dielectric fluid provided an improvement for the resistance of high temperature (i.e., 75° C.) aged mini-capacitors, operating at an elevated temperature (i.e., 55° C.), to device failure. With regards to the 55° C. step stress data, Control A mini-capacitors, having a pad thickness of 1.2 mil, showed failures within a range of 180 to 190% of the rated voltage. In particular, 67% of the Control A mini-capacitors failed at 180% of the rated voltage whereas 33% of the Control A mini-capacitors failed at 190% of the rated voltage. Mini-capacitors having the filled with dielectric fluids of Examples 5 and 6 showed failures within a range of 190% to 200% of the rated voltage. Specifically, 91% of the mini-capacitors failed at 190% of the rated voltage or higher. Notably, Example 6 comprising 0.8% BMAQ and 0.8% ERL-4299 provide for and having 3 dielectric layers demonstrated a failure level at 200% of the rated voltage for all tested mini-capacitor samples. The results for the elevated temperature step stress tests are shown below in Table 8.

TABLE 8

| | Control A | | Example 5 | | Example 6 | |
|---|---|---|---|---|---|---|
| | Number of Dielectric Layers: | | | | | |
| | 2 | 3 | 2 | 3 | 2 | 3 |
| Failure Level | 180 | 190 | 190 | 190 | 190 | 200 |
| (% of Rated | 190 | 180 | 190 | 200 | 190 | 200 |
| Voltage) | 180 | 180 | 190 | 200 | 180 | 200 |

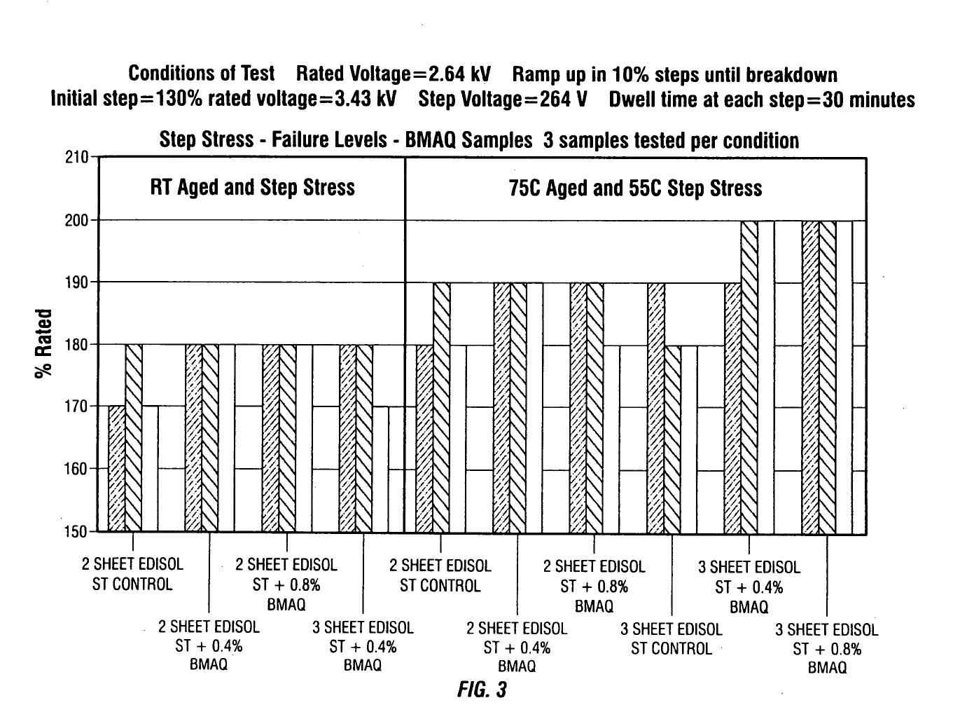

FIG. 3 illustrates the percent of rated voltage at which a dielectric failure occurred for both the room temperature step stress test and the elevated temperature step stress test. The percent of rated voltage at which a dielectric failure occurred for the room temperature step stress test is illustrated on the left side of the figure, whereas the percent of rated voltage at which a dielectric failure occurred for the elevated temperature step stress test is illustrated on the right side of the figure. As can be seen, mini-capacitors filled with the dielectric fluids of Examples 5 and 6, comprising 0.4 and 0.8% BMAQ, respectively, demonstrated improved resistance to failure at room temperature and at the elevated ambient temperature of 55° C., as compared to mini-capacitors filled with the Control A dielectric fluid, which includes ERL-4299, but not BMAQ.

Mini-capacitors filled with the Control A dielectric fluid and dielectric fluids comprising BMAQ were prepared using the method described above for the AC to DC Switch Testing. These mini-capacitors were aged for 1000 hours at an elevated ambient temperature of 75° C. Tests on these mini-capacitors were conducted using a partial discharge detector at 55° C. to determine the DIV and the DEV.

The results show that mini-capacitors filled with a dielectric fluid comprising BMAQ demonstrated an improvement in the DIV by 4% to 7.3% at an ambient temperature of 55° C., depending on the amount of BMAQ added. The results also provide that mini-capacitors filled with a dielectric fluid comprising BMAQ showed an improvement in the DEV by 3.0% to 9.1% at an ambient temperature of 55° C., depending on the amount of BMAQ added.

Three (3) mini-capacitors comprising capacitor packs having three (3) dielectric layers were constructed for each of Control A and Example 6 using the method described above for the AC to DC Switch Testing. A third step stress test was conducted using these mini-capacitors. These mini-capacitors were equilibrated and unenergized at room temperature overnight. The ambient temperature was maintained at −40° C. throughout the third step stress test. The mini-capacitors were energized and operated at 130% of the rated voltage until dielectric failure occurred. For this particular example, the rated voltage of the mini-capacitors was 2.64 kV and the initial step was at 3.43 kV.

The results demonstrate that mini-capacitors filled with dielectric fluids with or without BMAQ all failed at 130% of the rated voltage at −40° C. However, the addition of BMAQ to a dielectric fluid greatly improved the amount of time a mini-capacitor may withstand electrical stress. In particular, mini-capacitors filled with a dielectric fluid comprising BMAQ may be able to withstand electrical stress (i.e., 130% rated voltage) at −40° C. significantly longer than mini-capacitors filled in the Control A dielectric fluid. In general, the results demonstrated that the addition of 0.8% BMAQ to a dielectric fluid greatly improved the mini-capacitor's resistance to device failure at an ambient temperature of −40° C. The results for the −40° C. step stress tests were recorded as a range of time and are shown below in Table 9. In general, mini-capacitors filled with the dielectric fluid of Example 6 withstood electrical stress at 130% of the rated voltage significantly longer than mini-capacitors filled with the Control A dielectric fluid.

TABLE 9

| | Control A | Example 6 |
|---|---|---|
| Number of Dielectric Layers: | 3 | 3 |
| Minutes Operated Under | <1 | 20-30 |
| 130% Rated Voltage | <1 | 1-2 |
| | <1 | 20 |

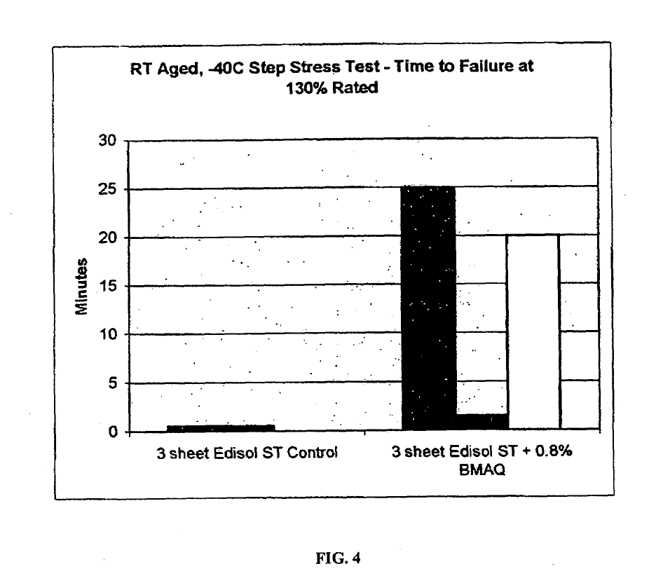

The results of Table 9 also are provided in FIG. 4. The amount of time withstood by mini-capacitors filled with the Control A dielectric fluid are illustrated on the left side of the figure, whereas the amount of time withstood by mini-capacitors filled with a dielectric fluid comprising 0.8% BMAQ are illustrated on the right side of the figure.

### DC Breakdown Testing

Ten (10) mini-capacitors comprising capacitor packs having two (2) dielectric layers, having a pad thickness of 1.2 mil, were constructed for each of Control A and Examples 1, 2, 5, and 6 using the method described above for the AC to DC Switch Testing. In addition, three (3) mini-capacitors comprising capacitor packs having three (3) dielectric layers, having a pad thickness of 1.2 mil, were constructed for each of Control A and Examples 1, 2, 5, and 6. To simulate high temperature repeated use, the mini-capacitors were aged for 1000 hours at an elevated ambient temperature of 75° C. The ambient temperature was maintained at 75° C. throughout the DC breakdown test. The mini-capacitors were energized with increasing DC voltage until dielectric failure occurred.

Although a wide range for deviation can be seen, the results, nonetheless, suggest that the addition of BMAQ to a dielectric fluid provided an improved resistance to DC breakdown for high temperature (i.e., 75° C.) aged mini-capacitors, operating at the same elevated temperature (i.e., 75° C.). It also was observed that similar levels of improvement were demonstrated by dielectric fluids having different amounts of BMAQ. The results for this DC breakdown test are shown below in Table 10.

TABLE 10

| | Number of | Avg DC | | Number of | Avg DC | |
|---|---|---|---|---|---|---|
| Dielectric | Dielectric | Breakdown | Standard | Dielectric | Breakdown | Standard |
| Fluid | Layers | (kV) | Deviation | Layers | (kV) | Deviation |
| Control A | 2 | 9.88 | 1.478 | 3 | 10.12 | 1.012 |
| Example 1 | 2 | 10.85 | 1.940 | 3 | 10.23 | 2.215 |
| Example 2 | 2 | 10.68 | 2.075 | 3 | 11.22 | 0.887 |
| Example 5 | 2 | 11.08 | 1.850 | 3 | 10.28 | 1.794 |
| Example 6 | 2 | 10.70 | 1.873 | 3 | 11.22 | 1.704 |

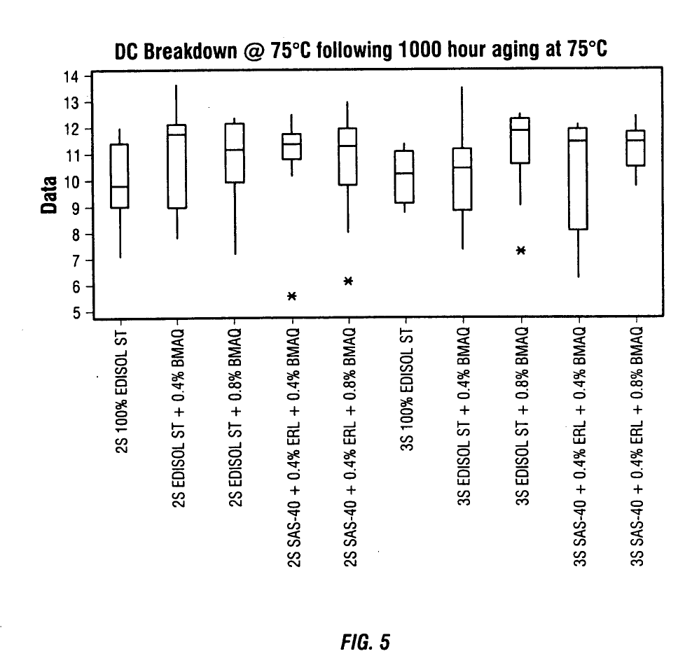

FIG. 5 provides the results for this DC breakdown test in a box plot. One skilled in the art would understand that box plots summarize information about the shape, dispersion and center of a set of data and can also identify data points that may be outliers the set of data. A top edge of the each vertical bar represents the first quartile (Q1), while a bottom edge of each vertical bar represents the third quartile (Q3) of the set of data. The vertical bar represents the interquartile range (IQR), or middle 50% of the set of data. The line drawn through the box represents the median of the data. A line extending from the top edge of each vertical bar extends outward toward the highest values in the data set, excluding outliers. Similarly, a line extending from the bottom edge of each vertical bar extends outward toward the lowest values in the data set. Extreme values, or outliers are represented by asterisks. These values are identified as outliers because the values are greater than Q3 or less than Q1 by more than 1.5 times the IQR. If the data are fairly symmetric, the median line will be roughly in the middle of the IQR box and the whiskers will be similar in length. If the data are skewed, the median may not fall in the middle of the IQR box, and one whisker will likely be noticeably longer than the other. One skilled in the art would understand that a wide range of deviations is typically observed when evaluating dielectric breakdown. However, significance of the data may be attributable to the distribution of the data set. As can be seen, the data for dielectric fluids comprising BMAQ demonstrate an increase in the DC breakdown for the overall population as compared to Control A.

A second DC breakdown test was conducted by increasing the applied DC voltage at a rate of 500 V/sec until dielectric failure was observed. Mini-capacitors were constructed using the method described above for the AC to DC Switch Testing. Ten (10) mini-capacitors, having a pad thickness of 1 mil, were filled with each of the Control A dielectric fluid and comparative compositions, Examples 5 and 7, which comprise BMAQ and ERL-4299 according to Table 11. Example 5A contains the same amounts of BMAQ and ERL-4299 as Example 5. However, Example 5A is prepared in a large batch using commercial manufacturing equipment whereas Example 5 is prepared in small batches in the laboratory.

TABLE 11

| | | | Example | |
|---|---|---|---|---|
| | Control A | Example 5 | 5A | Example 7 |
| Components | | Weight % | | |
| BMAQ | — | 0.4 | 0.4 | 0.1 |
| (Alfa Aesar, 97% | | | | |
| purity) | | | | |
| ERL-4299 | 0.8 | 0.8 | 0.8 | 0.8 |
| (Dow Chemical) | | | | |
| epoxide scavenger | | | | |

While there were some deviations between the data generated from multiple samples for each type of mini-capacitor, the results were evaluated using a statistical t-test, which measures the statistical significance of differences between two populations of data, and demonstrated with a high degree of confidence that the addition of 0.4% BMAQ to a dielectric fluid improved resistance to DC breakdown. The results for the second DC breakdown test are presented below as an average of and the standard deviation for 15 samples for each type of mini-capacitor in Table 12.

TABLE 12

| | Control A | Example 5 | Example 5A | Example 6 |
|---|---|---|---|---|
| Average: | 6.96 | 9.45 | 8.93 | 8.31 |
| Standard Deviation: | 0.504 | 2.056 | 1.783 | 1.665 |

### AC and DC Breakdown Testing

Mini-capacitors were constructed using the method described above for the AC to DC Switch Testing. Comparative compositions, Examples 8 through 12, were each prepared in small batches in the laboratory by adding BMAQ and ERL-4299 (Dow Chemical Co.) according to Table 13 to SAS-40, a commercial dielectric fluid, whereas ERL-4299, but not BMAQ, was added in Control B. The mini-capacitors, having a pad thickness of 1 mil, were filled with each of Control B or Examples 8 through 12.

TABLE 13

| | | | | Example | Example | Example |
|---|---|---|---|---|---|---|
| | Control B | Example 8 | Example 9 | 10 | 11 | 12 |
| Components | Weight % | | | | | |
| BMAQ | — | 0.1 | 1 | 0.1 | 1 | 0.5 |
| (Alfa Aesar, 97% | | | | | | |
| purity) | | | | | | |
| ERL-4299 | 0.6 | 0.1 | 1 | 1 | 0.1 | 0.8 |
| (Dow Chemical) | | | | | | |
| epoxide | | | | | | |
| scavenger | | | | | | |

To simulate high temperature repeated use, the mini-capacitors were aged for 4376 hours at an elevated ambient temperature of 75° C. The ambient temperature was maintained at 75° C. throughout the AC and DC breakdown tests. Some of the mini-capacitors for each of Control B and Examples 8 through 12 were energized with increasing DC voltage until dielectric failure occurred, while other mini-capacitors for each of Control B and Examples 8 through 12 were energized with increasing AC voltage until dielectric failure occurred.

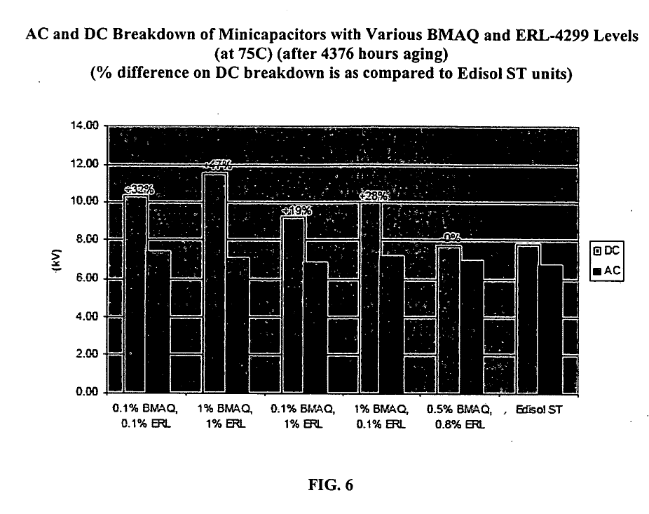

The results demonstrate that the addition of BMAQ to a dielectric fluid provided a significant improvement in the resistance to DC breakdown of high temperature (i.e., 75° C.) aged mini-capacitors operating at the same elevated temperature (i.e., 75° C.). The tests were conducted in triplicate using three (3) mini-capacitors for each composition and the results for these AC and DC breakdown tests are shown in FIG. 6 with specific values provided in Table 14. The results are provided as an average, along with the standard deviation, of the three data points (in kV) for each composition.

TABLE 14

| Control | Ex- | Ex- | Exam- | Example | Example |
|---|---|---|---|---|---|
| B | ample 8 | ample 9 | ple 10 | 11 | 12 |

DC Breakdown

| | | | | | | |
|---|---|---|---|---|---|---|
| Average: | 7.81 | 10.33 | 11.48 | 9.26 | 9.97 | 7.73 |
| Standard | 0.300 | 0.824 | 1.777 | 1.095 | 2.603 | 0.380 |
| Deviation: | | | | | | |

AC Breakdown

| | | | | | | |
|---|---|---|---|---|---|---|
| Average: | 6.72 | 7.40 | 7.03 | 6.80 | 7.15 | 6.98 |
| Standard | 0.625 | 0.251 | 0.142 | 0.323 | 0.206 | 0.286 |
| Deviation: | | | | | | |

### DC Breakdown Testing

Mini-capacitors having pad thicknesses of 0.8 mil and 1.2 mil were constructed using a method similar to that described above for the AC to DC Switch Testing. Comparative dielectric fluids compositions: (i) SAS-40 with 0.8% ERL-4299 (Control A), (ii) SAS-40 with 0.8% ERL-4299 and monobenzyltoluene in an equal blend, and (iii) SAS-40 with 0.8% ERL-4299 and 0.5% BMAQ (Exampled 12) were prepared. Both types of mini-capacitors were prepared for each of the dielectric fluids.

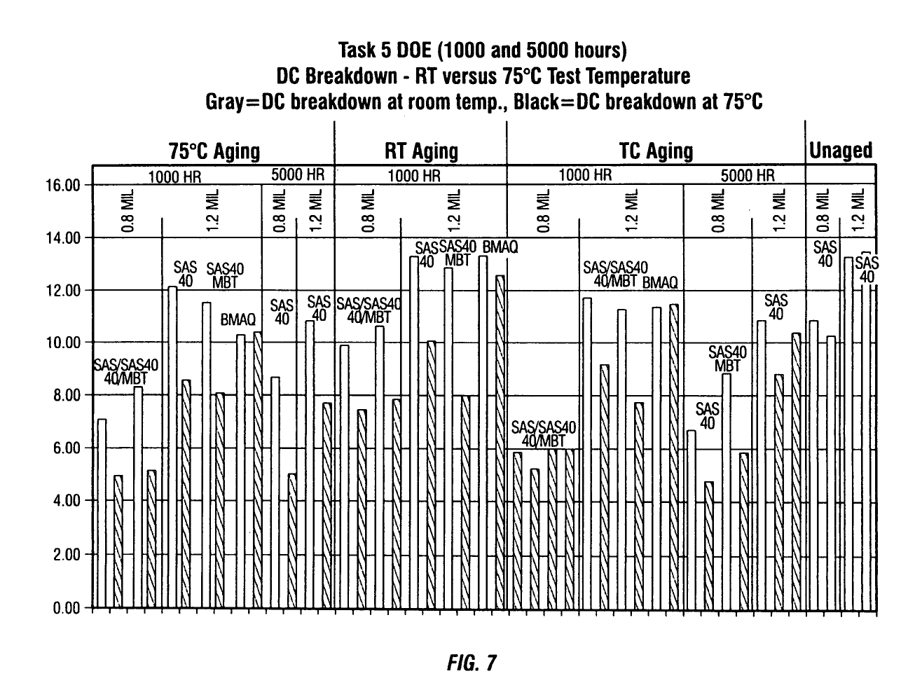

Another DC breakdown test was conducted at room temperature and at an elevated ambient temperature of 75° C. To simulate various temperature ranges of use, one set of mini-capacitors were aged for 1000 hours at an elevated ambient temperature of 75° C., a second set of mini-capacitors were aged for 1000 hours at room temperature, and a third set of mini-capacitors were aged by temperature cycling between room temperature and 75° C., each condition held for one week for a full duration of 100 hours. Each set of mini-capacitors are then divided into two subsets. For one sub-set of mini-capacitors, the ambient temperature was maintained at room temperature whereas for the other sub-set of mini-capacitors, the ambient temperature was maintained at an elevated ambient temperature of 75° C. throughout the DC breakdown test. The mini-capacitors were energized with increasing DC voltage until dielectric failure occurred. The tests were conducted in triplicate using three (3) mini-capacitors for each composition and condition and the results for these DC breakdown tests are shown in FIG. 7 with specific values (in kV) provided for mini-capacitors having a pad thickness of 1.2 mil in Table 15. The results are provided as an average, along with the standard deviation, of the three data points for each composition and condition combination.

TABLE 15

| | | Aged for 1000 hours | | | | | |
|---|---|---|---|---|---|---|---|
| | | | | | | By temperature | |
| | | | | | | cycling between | |
| | | | | | | 75° C. | |
| | | | | At room | | and room | |
| | | At 75° C. | | temperatures | | temperature | |
| | | Temperature for DC Breakdown Testing | | | | | |
| | | Room | | Room | | Room | |
| | | Temp. | 75° C. | Temp. | 75° C. | Temp. | 75° C. |
| Control | Avg. | 12.11 | 8.56 | 13.30 | 9.98 | 11.66 | 9.15 |
| A | St. | 1.67 | 0.09 | 0.74 | 0.25 | 0.4 | 1.19 |
| | Dev. | | | | | | |
| Exam- | Avg. | 10.33 | 10.30 | 13.27 | 12.57 | 11.30 | 11.47 |
| ple 12 | St. | 0.81 | 1.56 | 0.23 | 0.59 | 0.35 | 1.05 |
| | Dev. | | | | | | |

### AC De-Energization Modeling

To simulate repeat use and stress on the capacitor at elevated ambient temperatures, the capacitors were subject to alternating AC and DC stresses at an ambient temperature of about 65° C. Ten (10) mini-capacitors fill with the Control B dielectric fluid comprising SAS-40 with 0.6% ERL-4299, but not BMAQ, and ten (10) mini-capacitors filled with an exemplary dielectric fluid (Example 13) of the invention comprising SAS-40 with 0.6% ERL-4299 and 0.4% BMAQ, each with a pad thickness of 1.2 mil were constructed to evaluate the AC de-energization of the capacitors of this exemplary embodiment. In addition, ten (10) mini-capacitors fill with the Control B dielectric fluid, and ten (10) mini-capacitors filled with Example 13, each with a pad thickness of 0.8 mil were also constructed.

These mini-capacitors were placed in a chamber having an elevated ambient temperature of 60° C. for this test. The mini-capacitors were energized and operated for 10 minutes with an AC voltage of 2.7 kV/mil. The mini-capacitors were then de-energized. Subsequent to de-energizing, the mini-capacitors were re-energized and operated for 10 minutes at a DC voltage 1.95 times the rated DC voltage of the capacitor. The rated DC voltage of the capacitor is generally obtained from the root-mean-squared (RMS) voltage for the capacitor unit. The mini-capacitors were then de-energized and the mini-capacitors were energized and operated for 10 with an AC voltage of 2.7 kV/mil. The alternating AC and DC stress de-energize/re-energize cycles were repeated every 10 minutes for 24 hours. If no dielectric failure occurred, the DC voltage is increased to 2.1 times the rated DC voltage of the capacitor and the AC and DC stress de-energize/re-energize cycles are repeated for another 24 hours with the AC stress maintained at 2.7 kV/mil. The AC and DC stress de-energize/re-energize cycles were repeated every 24 hours at increments 0.15 times the rated voltage until all mini-capacitors have failed. For each failed mini-capacitor, tests comparing stress level with pre-established DIV values are conducted to confirm that the capacitor failures were caused by the energization/de-energization cycles and not by partial discharges. The results for the AC energization modeling is provided below in Table 16.

TABLE 16

| DC Voltage Stress: | | | | |
|---|---|---|---|---|
| X times the rated | Pad Thickness of 0.8 mil | | Pad Thickness of 1.2 mil | |
| DC voltage | Control B | Example 13 | Control B | Example 13 |
| 1.95 | 10% | | 20% | |
| 2.1 | 40% | 10% | | |
| 2.25 | | 20% | | |
| 2.4 | 50% | | | |
| 2.55 | | | 30% | |
| 2.7 | 80% | 40% | 40% | |
| 2.85 | | 50% | | 10% |
| 3 | 90% | 80% | 50% | 20% |
| 3.15 | | 90% | | 40% |
| 3.3 | | 100% | | |
| 3.45 | 100% | | | |
| 3.6 | | | | 70% |
| 3.75 | | | 60% | 90% |
| 3.9 | | | 70% | 100% |
| 4.05 | | | 80% | |
| 4.2 | | | 90% | |
| 4.35 | | | | |
| 4.5 | | | | |

The results demonstrate that the addition of BMAQ to a dielectric fluid provided a significant improvement in the resistance to failure under repeat AC and DC stress de-energize/re-energize cycles at an elevated temperature of 60° C. for DC voltage stresses of at least 3 times the rated DC voltage. Moreover, typical operations for a capacitor would suggest that the level of most concern for resistance to failure would be at 2.7 times the rated voltage. As shown above, at this particular level of DC voltage stress, mini-capacitors filled with a dielectric fluid having BMAQ clearly shows improved resistance to failure. Notably, for mini-capacitors having a pad thickness of 0.8 mil and tested at 2.7 times rated voltage DC, those filled with a dielectric fluid without BMAQ as an additive failed at twice the rate as those filled with a dielectric fluid containing BMAQ. Even more noticeably, for mini-capacitors having a pad thickness of 1.2 mil, 40% of the mini-capacitors filled with a dielectric fluid without BMAQ failed at a DC stress of 2.7 times the rated voltage whereas those filled with a dielectric fluid containing BMAQ did not begin to fail until it was subject to a DC stress of 2.85 times the rated voltage or higher.

### Full-Size Capacitors

The ability of a combination of anthraquinone and a scavenger to improve resistance to device failures also was investigated by preparing full-size capacitors having dielectric fluids comprising the combination. The exemplary full-size capacitors were filled with either the Control B dielectric fluid comprising 0.6% ERL-4299, but not BMAQ, or with an exemplary dielectric fluid of the invention comprising SAS-40 with 0.6% ERL-4299 and 0.5% BMAQ (Example 14). Unless otherwise noted, the dielectric fluids for the full-size capacitors were produced in large batches using commercial manufacturing equipment. The full-size capacitors were, however, varied in their designs according to Table 17 below.

TABLE 17

| Capacitor | Pad Thickness | Rated Voltage |
|---|---|---|
| Capacitor 1 | 1.0 mil | 2200 V/mil |
| Capacitor 2 | 0.94 mil | 1767 V/mil |
| Capacitor 3 | 1.2 mil | 2000 V/mil |
| Capacitor 4 | 0.84 mil | 2143 V/mil |
| Capacitor 5 | 1.0 mil | 1990 V/mil |
| Capacitor 6 | 0.8 mil | 2000 V/mil |
| Capacitor 7 | 1.0 mil | 2000 V/mil |
| Capacitor 8 | 1.05 mil | 1895 V/mil |

### Conditioning Tests

To investigate the ability of the full-size capacitors to withstand repeated use, the capacitors were subjected to various electrical stresses for prolonged periods of time. Sixteen (16) samples of Capacitor 1 filled with a dielectric fluid comprising 0.5% BMAQ and 0.6% ERL-4299 (Example 14). All samples of Capacitor 1 were subject to a number of routine tests to evaluate the integrity of the capacitor. Prior to the initiation of conditioning tests, 1 of the 16 capacitors failed. An AC voltage of 15 kV was applied for 60 hours to the remaining 15 samples of Capacitor 1 filled with a dielectric fluid of Example 14. All 15 samples of Capacitor 1 successfully passed the conditioning test, where a breakdown of the dielectric system did not occur.

Six (6) samples of Capacitor 2 filled with a dielectric fluid of Example 14 were subjected to a DC voltage at 120% of the rated voltage for 50 hours, followed by a DC voltage at 140% of the rated voltage for 60 hours. All six samples of Capacitor 2 successfully passed the test, where a breakdown of the dielectric system did not occur.

Five (5) samples of Capacitor 3 filled with a dielectric fluid of Example 14 were subjected to an AC voltage at 125% of the rated voltage for 50 hours, followed by an AC voltage at 150% for 100 hours. Only two (2) samples successfully passed the test. One sample failed after 4 minutes under 125% of the rated voltage. Another sample failed after 50 hours at 125% of the rated voltage and 32 hours at 135% of the rated voltage. A third sampled failed when subjected to an AC voltage at 125% of the rated voltage.

### −40° C. Step Stress Testing

The ability of the dielectric fluids comprising a combination of an anthraquinone and a scavenger to withstand electrical stresses at low temperatures was investigated using full-size capacitors. The capacitors were equilibrated and unenergized at room temperature overnight. The ambient temperature was maintained at −40° C. throughout the −40° C. step stress test. The capacitors were energized and operated at 130% of the rated voltage. The capacitors were then de-energized for a period of at least 4 hours. Subsequent to de-energizing, the capacitors were re-energized and operated for 30 minutes at a 10% increase, which is 140% of the rated voltage. The capacitors were de-energized overnight. The de-energize/re-energize cycles were repeated at 10% voltage increments (i.e., at 150%, 160%, 170%, 180%, 190% and 200% of rated voltage) until dielectric failure occurred.

Two (2) samples of Capacitor 3 filled with a dielectric fluid of Example 14 were subjected to the −40° C. step stress test. One (1) sample failed after 6 minutes at 160% of the rated voltage, whereas the other sample failed after 5 minutes at 150% of the rated voltage.

Two (2) samples of Capacitor 4 filled with a dielectric fluid of Example 14 were subjected to the −40° C. step stress test. One (1) sample failed after 6 minutes at 170% of the rated voltage, whereas the other sample failed after 15 minutes at 160% of the rated voltage. In addition, two (2) samples of Capacitor 4 filled with the Control B dielectric fluid were also tested. Both samples failed after 6 minutes at 170% of the rated voltage. Further, two (2) more samples of Capacitor 4 were prepared with the Control B dielectric fluid prepared in small batches in the laboratory. One sample failed after 7 minutes at 170% of the rated voltage, whereas the other sample failed after 1 minute at 180% of the rated voltage.

Two (2) samples of Capacitor 5 filled with a dielectric fluid of Example 14 were subjected to the −40° C. step stress test. One sample failed at 150% of the rated voltage, whereas the other sample failed at 130% of the rated voltage. In addition, three (3) samples of Capacitor 5 filled with the Control B dielectric fluid were also tested. One sample failed after 2 minutes at 140% of the rated voltage, another sample failed after 7 minutes at 130% of the rated voltage, and the third sample failed after 18 minutes at 160% of the rated voltage. Further, a sample of Capacitor 5 was constructed using the Control B dielectric fluid mixed in small batches in the laboratory. The sample failed after 23 minutes at 130% of the rated voltage.

### Room Temperature Step Stress Testing

The ability of the dielectric fluids comprising a combination of an anthraquinone and a scavenger to withstand electrical stresses at room temperature was investigated using full-size capacitors. The capacitors were equilibrated and unenergized at room temperature overnight. The ambient temperature was maintained at room temperature throughout the room temperature step stress test. The capacitors were energized and operated at 130% of the rated voltage for 30 minutes. Subsequently, the capacitors were operated for 30 minutes at a 10% increase, which is 140% of the rated voltage. The increases in voltage were repeated at 10% increments (i.e., at 150%, 160%, 170%, 180%, 190% and 200% of rated voltage) until dielectric failure occurred.

Two (2) samples of Capacitor 3 filled with a dielectric fluid of Example 14 were subjected to the room temperature step stress test. One (1) sample failed after 28 minutes at 180% of the rated voltage, whereas the other sample failed after 2 minutes at 170% of the rated voltage.

Two (2) samples of Capacitor 4 filled with a dielectric fluid of Example 14 were subjected to the room temperature step stress test. Both samples failed at 210% of the rated voltage. In addition, two (2) samples of Capacitor 4 filled with the Control B dielectric fluid were also tested. One (1) sample failed after 1.4 hours at 180% of the rated voltage, whereas the other sample failed after 1 hour at 200% of the rated voltage. Further, two (2) more samples of Capacitor 4 were constructed using the Control B dielectric fluid mixed in small batches in the laboratory. One (1) sample failed after 16 minutes at 200% of the rated voltage, and the other sample failed after 7 minutes at 200% of the rated voltage. The results further suggest that the addition of BMAQ to a dielectric fluid does not result in any significant detrimental performance at room temperature.

Two (2) samples of Capacitor 5 filled with a dielectric fluid of Example 14 were subjected to the room temperature step stress test. One (1) sample failed after 2 minutes at 190% of the rated voltage, and the other sample failed after 5 minutes at 190% of the rated voltage.

### 55° C. Step Stress Testing

The ability of the dielectric fluids comprising a combination of an anthraquinone and a scavenger to withstand electrical stresses at warm temperatures was investigated using full-size capacitors. The capacitors were equilibrated and unenergized at 55° C. overnight. The ambient temperature was maintained at 55° C. throughout the 55° C. step stress test. The capacitors were energized and operated at 130% of the rated voltage. The capacitors were then de-energized for a period of at least 4 hours. Subsequent to de-energizing, the capacitors were re-energized and operated for 30 minutes at a 10% increase, which is 140% of the rated voltage. The capacitors were de-energized overnight. The de-energize/re-energize cycles were repeated at 10% voltage increments (i.e., at 150%, 160%, 170%, 180%, 190% and 200% of rated voltage) until dielectric failure occurred.

Two (2) samples of Capacitor 3 filled with a dielectric fluid of Example 14 were subjected to the 55° C. step stress test. One (1) sample failed after 13 minutes at 170% of the rated voltage, whereas the other sample failed instantaneously at 170% of the rated voltage.

Two (2) samples of Capacitor 4 filled with a dielectric fluid of Example 14 were subjected to the 55° C. step stress test. One sample failed after 8 minutes at 220% of the rated voltage, and the other sample failed after 2 minutes at 220% of the rated voltage. In addition, a sample of Capacitor 4 filled with the Control B dielectric fluid also was tested. The sample failed after 8 minutes at 210% of the rated voltage. Further, two (2) more samples of Capacitor 4 were constructed using the Control B dielectric fluid mixed in small batches in the laboratory. One (1) sample failed after 18 minutes at 200% of the rated voltage, and the other sample failed after 3 minutes at 210% of the rated voltage.

### −20° C. Step Stress Testing

The ability of the dielectric fluids comprising a combination of an anthraquinone and a scavenger to withstand electrical stresses at low temperatures also was investigated using full-size capacitors at −20° C. The capacitors were equilibrated and unenergized at room temperature overnight. The ambient temperature was maintained at −20° C. throughout the −20° C. step stress test. The capacitors were energized and operated at 130% of the rated voltage. The capacitors were then de-energized for a period of at least 4 hours. Subsequent to de-energizing, the capacitors were re-energized and operated for 30 minutes at a 10% increase, which is 140% of the rated voltage. The capacitors were de-energized overnight. The de-energize/re-energize cycles were repeated at 10% voltage increments (i.e., at 150%, 160%, 170%, 180%, 190% and 200% of rated voltage) until dielectric failure occurred.

Four (4) samples of Capacitor 3 filled with a dielectric fluid of Example 14 were subjected to the −20° C. step stress test. Two samples failed at 130% of the rated voltage, one (1) after 17 minutes and the other after 5 minutes. The remaining two (2) samples failed at 150% of the rated voltage, one (1) after 5 minutes, and the other after 4 minutes.

### High Temperature DC Residual Voltage Test

Two (2) full size capacitors filled with a Control C dielectric fluid comprising SAS-40 with 0.8% ERL-4299, but not BMAQ, and two (2) full size capacitors filled with an exemplary dielectric fluid of the invention comprising SAS-60 with 0.8% ERL-4299 and 0.4% BMAQ (Example 15), each with a pad thickness of 1.2 mil were constructed. These capacitors were designed with a rated voltage of 7.2 kV, a rated kilovolt-ampere reactive power (KVAR), which measures reactive power in an AC electric power system, of 200 and a design stress of 2000 v/mil.

To simulate repeat use and stress on the capacitor at elevated ambient temperatures, the capacitors were placed in a forced air environmental chamber and energized with an AC current at 110% of the rated voltage. The ambient temperature of the chamber was increased to 65° C. The capacitors were operated for at least 336 hours (14 days) under these temperature and AC voltage conditions. Subsequently, the capacitors were de-energized and the capacitance of each unit was measured. The de-energized capacitors were then place in a DC test cell and subject to a DC voltage at a level of 2.12 times the rated DC voltage. After reaching the desired DC voltage test level, the voltage supply was immediately removed and the capacitors were isolated with trapped DC charge for 5 minutes. After an isolation period of 5 minutes, the capacitors were shorted and the capacitance of the unit was re-measured. It was observed that both capacitors filled with a dielectric fluid containing 0.4% BMAQ successfully completed the required test sequence and both capacitors filled with the Control C dielectric fluid successfully completed the AC portion of the test but failed after exposure to the DC test. The capacitance of each of the above capacitors before and after the DC test is provided below in Table 18.

TABLE 18

| | | Capacitance | | |
|---|---|---|---|---|
| | AC Operation | Before DC | DC Test | Final |
| Test | @ 110%, 65° C. | Test | Level | Capacitance |
| Capacitor | (Hrs) | (uf) | (kV) | (uf) |
| Control C | 336 | 10.39 | 15.3 | 15.53 |
| Test 1 | | | | |
| Control C | 336 | 10.41 | 15.3 | 15.66 |
| Test 2 | | | | |
| Example 15 | 336 | 10.27 | 15.3 | 10.27 |
| Test 1 | | | | |
| Example 15 | 336 | 10.42 | 15.3 | 10.43 |
| Test 2 | | | | |

Many other modifications, features, and embodiments will become evident to a person of ordinary skill in the art having the benefit of the present disclosure. It should be appreciated, therefore, that many aspects of the invention were described above by way of example only and are not intended as required or essential elements of the invention unless explicitly stated otherwise. It should also be understood that the invention is not restricted to the illustrated embodiments and that various modifications can be made within the spirit and scope of the following claims.

What is claimed is:

1. An alternate-current electrical capacitor comprising a casing and a dielectric fluid in the casing, the dielectric fluid comprising:
about 0.1 to about 3 percent by weight of β-methylanthraquinone; and
about 0.1 to about 1 percent by weight of a cycloaliphatic epoxide resin.

2. The electrical capacitor of claim 1, wherein the cycloaliphatic epoxide resin is selected from a group consisting of bis(3,4-epoxycyclohexyl)adipate, 3,4-epoxycyclohexylmethyl 3,4-epoxycyclohexanecarboxylate, and (3′,4′-epoxycyclohexane)methyl, 3,4-epoxycyclohexyl-carboxylate.

3. The electrical capacitor of claim 2, wherein the cycloaliphatic epoxide resin is bis(3,4-epoxycyclohexyl)adipate.

4. The electrical capacitor of claim 1, wherein the dielectric fluid comprises about 0.3 percent by weight to about 0.8 percent by weight of β-methylanthraquinone.

5. The electrical capacitor of claim 4, wherein the dielectric fluid comprises about 0.3 percent by weight to about 0.6 percent by weight of β-methylanthraquinone.

6. The electrical capacitor of claim 5, wherein the dielectric fluid comprises about 0.35 percent by weight to about 0.5 percent by weight of β-methylanthraquinone.

7. The electrical capacitor of claim 6, wherein the dielectric fluid comprises about 0.5 percent by weight of β-methylanthraquinone.

8. The electrical capacitor of claim 6, wherein the dielectric fluid comprises about 0.4 percent by weight of β-methylanthraquinone.

9. The electrical capacitor of claim 1, wherein the dielectric fluid further comprises:
benzyltoluene;
1,1-diphenylethane; and
about 0.1 to about 3 percent by weight of 1,2-diphenylethane.

10. A dielectric fluid comprising:
about 0.1 to about 3 percent by weight of β-methylanthraquinone; and
about 0.1 to about 1 percent by weight of cycloaliphatic epoxide resin.

11. The dielectric fluid of claim 10, wherein the cycloaliphatic epoxide resin is selected from a group consisting of bis(3,4-epoxycyclohexyl)adipate, 3,4-epoxycyclohexylmethyl 3,4-epoxycyclohexanecarboxylate, and (3′,4′-epoxycyclohexane)methyl, 3,4-epoxycyclohexyl-carboxylate.

12. The electrical capacitor of claim 11, wherein the cycloaliphatic epoxide resin is bis(3,4-epoxycyclohexyl)adipate.

13. The dielectric fluid of claim 10, wherein the dielectric fluid comprises about 0.3 percent by weight to about 0.8 percent by weight of β-methylanthraquinone.

14. The dielectric fluid of claim 13, wherein the dielectric fluid comprises about 0.3 percent by weight to about 0.6 percent by weight of β-methylanthraquinone.

15. The dielectric fluid of claim 14, wherein the dielectric fluid comprises about 0.35 percent by weight to about 0.5 percent by weight of β-methylanthraquinone.

16. The dielectric fluid of claim 15, wherein the dielectric fluid comprises about 0.5 percent by weight of β-methylanthraquinone.

17. The dielectric fluid of claim 15, wherein the dielectric fluid comprises about 0.4 percent by weight of β-methylanthraquinone.

18. The dielectric fluid of claim 10, wherein the dielectric fluid further comprises:
benzyltoluene;
1,1-diphenylethane; and
about 0.1 to about 3 percent by weight of 1,2-diphenylethane.

19. A method of reducing likelihood of failure of a capacitor operating under alternating-current at an elevated ambient temperature, wherein the capacitor comprises a capacitor casing and a plurality of dielectric layers, comprising:
filling the capacitor casing with a dielectric fluid comprising about 0.1 to about 3 percent by weight of β-methylanthraquinone and about 0.1 to about 1 percent by weight of a cycloaliphatic epoxide resin to the dielectric fluid.

20. The method of claim 19, wherein the cycloaliphatic epoxide resin is selected from a group consisting of bis(3,4-epoxycyclohexyl)adipate, 3,4-epoxycyclohexylmethyl 3,4-epoxycyclohexanecarboxylate, and (3′,4′-epoxycyclohexane)methyl, 3,4-epoxycyclohexyl-carboxylate.

21. The method of claim 20, wherein the cycloaliphatic epoxide resin is bis(3,4-epoxycyclohexyl)adipate.

22. The method of claim 19, wherein the elevated ambient temperature is above 40° C.

23. The method of claim 22, wherein the elevated ambient temperature is above 55° C.

24. The method of claim 23, wherein the elevated ambient temperature is about 75° C.

25. The method of claim 19, wherein a discharge inception voltage (DIV) or a discharge extinction voltage (DEV) is increased by at least 3%.

26. A method of reducing likelihood of failure of an alternate-current electrical capacitor, wherein the capacitor comprises a capacitor casing and a plurality of dielectric layers and is designed to have a rated voltage, comprising:
filling the capacitor casing with a dielectric fluid comprising an effective amount of β-methylanthraquinone for reducing the likelihood of failure of the alternate-current electrical capacitor operating at a direct current (DC) voltage level of less than 3 times the rated voltage.

27. The method of claim 26, wherein the dielectric fluid comprises about 0.4 percent by weight of β-methylanthraquinone.

28. The method of claim 26, wherein the direct current (DC) voltage level is less than 2.7 times the rated voltage.
